(19) United States
(12) Patent Application Publication
(10) Pub. No.: US 2006/0197821 A1
(43) Pub. Date: Sep. 7, 2006

(54) APPARATUS FOR IMAGE CORRECTION OF A LASER PRINTER AND METHOD FOR THE SAME

(76) Inventor: Yung-Shan Lin, Ping-Tung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,797

(22) Filed: Mar. 7, 2005

(51) Int. Cl. B41J 2/385

(52) U.S. Cl. 347/116

(57) ABSTRACT

An apparatus for image correction of a laser printer and its method. The apparatus and method are applied to a laser printer using laser or light-emitting diode (LED) beam-scanning technology for performing a printing procedure thereof. The method disposes a sensing unit inside the laser printer, uses multiple sensors of the sensing unit to receive optical signals of the scanning beam emitted from a light-emitting unit and convert the optical signals into multiple photoelectric signals, uses an image-processing unit to receive and process the photoelectric signals, converts the photoelectric signals into multiple signal stripe lines and shows the signal stripe lines on an image-displaying unit, and determines whether the light-emitting unit has disposition deviation according to the status of the signal stripe lines and adjusts the light-emitting unit's position to remove the disposition deviation.

### BACKGROUND OF INVENTION

1. Field of the Invention

The present invention is related to an apparatus for image correction of a laser printer and a method for the same, and more particularly, to the position correction of the light-emitting unit disposed inside the laser printer.

2. Description of the Prior Art

Conventional copiers, printers or facsimile machines use Electro-photography as the core technology for printing. This technology uses a light beam with a specific wavelength to change the distribution of the electrostatic charges of a photoelectric unit to produce a photographic image. During the printing process, a charging unit is first used to charge a photoconductive drum to place uniformly electric charges on a peripheral surface thereof. Then, the pixels of a document image are converted into on-off signal to drive a light source. According to the on-off signal, the laser beam impinges some areas of the surface of the photoconductive drum and the electric charges on these areas are discharged to lower the electric potential. Thus, these areas can attract the toner to produce the photographic image for printing.

There are many factors affecting the printing quality in the foresaid printing process, such as distribution of the electrostatic charges, exposure of the photoconductive drum, the difference of the electric potentials between the exposed region and unexposed regions, the descending rate of the electric potentials of the exposed regions and so forth. Therein, the position inaccuracy of the scanning light source, which can be a laser or a light-emitting diode (LED), causes the printing displacements and skews.

In the prior art, U.S. Pat. No. 6,281,918 discloses a printhead skew adjustment mechanism for a chromatic laser printer. Reference is made to FIG. 1A. The laser printer 10 includes multiple laser printheads 12, 14, 16 and 18, a black toner cartridge 20, a magenta toner cartridge 22, a cyan toner cartridge 24, a yellow toner cartridge 26 and a transfer belt 36 in contact with multiple photoconductive drums 28, 30, 32 and 34 for transferring papers. Each of the laser printheads 12, 14, 16 and 18 is capable of emitting a laser beam, i.e. the laser beam 38, 40, 42 or 44, to impinge upon a corresponding one of the photoconductive drums 28, 30, 32 and 34. After being impinged upon by the laser beams, the lower potential areas formed on the surface of the photoconductive drums 28, 30, 32 and 34 can be used to attract the toners for printing a colored picture.

Reference is made to FIG. 1B, which is a detailed diagram of the laser printhead 12 of the laser printer 10. The laser printhead 12 emits the laser beam 38 via a slot 116 to scan the photoconductive drums 28 according to the orientation of the arrow 85 to form a scan line 139. A sensor (not shown) connected to the laser printhead 12 is used to generate a position signal for a controller (not shown) to check whether the laser printhead 12 is skewed. Thereby, the controller generates a correction signal for a related mechanism to adjust the position of the laser printhead 12. For example, the pivot axis 114 can be used to adjust the angle of the laser printhead 12.

In addition, U.S. Pat. No. 6,486,906 belonging to Lexmark Company also discloses a printhead skew adjustment mechanism for a laser printer. Reference is made to FIG. 2. The laser printer has a sensing unit 200 inside. The sensing unit 200 is connected to multiple toner cartridges of the laser printer and used to record the positions of these toner cartridges relative to a main axis and check the skew states of the photoconductive drums. When the printer produces a correction image, the sensing unit 200 collects the related image information to drive the adjustment mechanism for skew correction. As shown in FIG. 2, the sensing unit 200 includes a rigid plate 201 having multiple photoconductive drums 76, 78, 80 and 82 disposed thereon. Each end of the photoconductive drums 76, 78, 80 and 82 has a sensor 50 to detect the skew in the orientation of arrow 52 or 54. Thereby, the adjustment mechanism can adjust the position or angle of the printhead to remove the skew. The adjustment operation is not described in detail here.

According to the above description, the prior art can be used to remove the skew of the laser printhead. However, in addition to the skew of the laser printhead, the inaccurate disposition of the components of the laser printer may also make the laser-scanning unit (LSU) operate inaccurately, therefore affecting the printing quality of the laser printer.

### SUMMARY OF INVENTION

The present invention provides a method for image correction of a laser printer. The method includes disposing a sensing unit inside the laser printer; emitting a scanning beam from a light-emitting unit to the sensing unit; using a plurality of sensors of the sensing unit to receive optical signals of the scanning beam and convert the optical signals into a plurality of photoelectric signals; using an image-processing unit to receive and process the photoelectric signals; converting the photoelectric signals into a plurality of signal stripe lines and showing the signal stripe lines by using an image-displaying unit; and determining whether the light-emitting unit has disposition deviation according to the signal stripe lines and correcting the light-emitting unit's position.

The present invention also provides an apparatus for image correction of a laser printer. It includes a laser printhead, a sensing unit, multiple sensors, an image-processing unit, an image-displaying unit and a correction unit.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

The foregoing aspects and many of the attendant advantages of this invention will be more readily appreciated as the same becomes better understood by reference to the following detailed description, when taken in conjunction with the accompanying drawings, wherein:

FIG. 1A is a schematic diagram of a conventional chromatic laser printer;

FIG. 1B is a detailed diagram of a laser printhead disposed inside a laser printer in the prior art;

FIG. 2 is a schematic diagram of a conventional correction apparatus for the laser printhead;

FIG. 3 is a schematic diagram of a laser electrographic machine in accordance with the present invention;

FIG. 4A is a schematic diagram of a correction apparatus in accordance with a preferred embodiment of the present invention;

FIG. 4B shows an enlarged diagram of the sensing unit in accordance with a preferred embodiment of the present invention;

FIG. 5 is a block diagram of an image-processing system used in the method of the present invention;

FIGS. 6A-6B illustrate scan lines of the scanning beam emitted to the sensing unit in accordance with the present invention;

FIG. 6C illustrates various photoelectric signals shown by the image-displaying unit in accordance with the present invention; and

FIG. 7 is a flow chart of the correction method in accordance with the present invention.

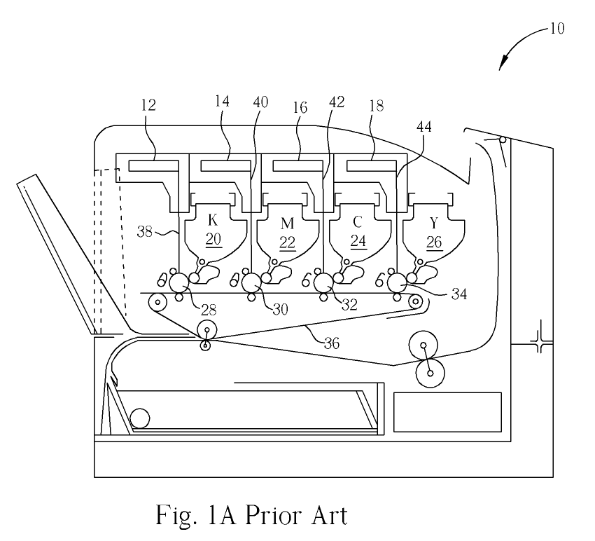

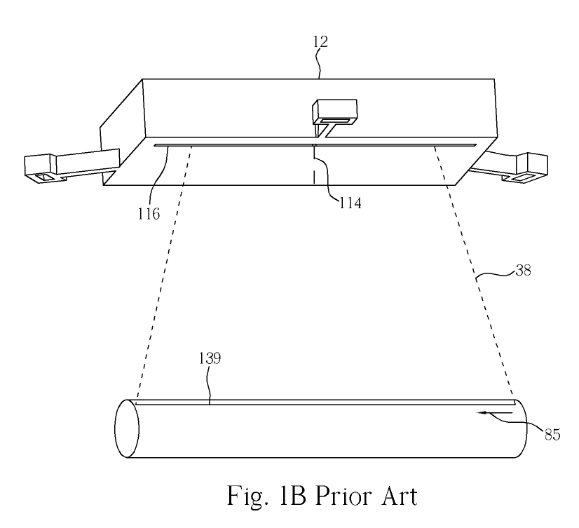

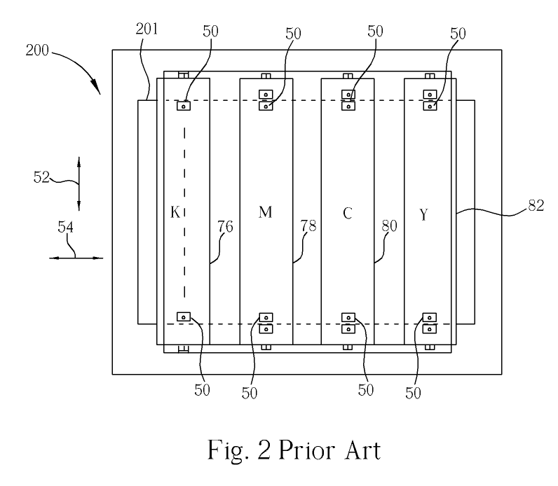

### DETAILED DESCRIPTION

In order to diagnose and solve the problems of the printing skews and displacements, the preferred embodiment of the present invention provides an apparatus for image correction and a method for the same. The preferred embodiment of the present invention is designed to prevent the inaccuracy of the LSU by checking the displacement of the laser scan lines in the vertical direction. The inaccuracy of the LSU is caused by the inaccurate combination of the components of the laser electrographic machine made according to the present electrophotographic technology. The inaccuracy of the LSU causes the printing errors, such as the printing skews. In general, by checking whether the laser or LED light source can be driven to scan the correct regions or not, the preferred embodiments of the present invention has following features:

1. The preferred embodiment of the present invention can be used to eliminate the skew of the laser beam emitted from the LSU disposed in the laser printer, wherein the skew of the laser beam is caused by the inaccurate combination of the components of the LSU;

2. The preferred embodiment of the present invention can be used to correct the skew of the image produced on a photoconductive drum, wherein the skew of the image is caused by inaccurately installing the LSU into the laser printer;

3. The preferred embodiment of the present invention can be used to eliminate the printing skews caused by the accumulative deviation of the assembly of the laser printer; and

4. The preferred embodiment of the present invention can be used to check whether the Laser or LED light source scans the correct regions or not.

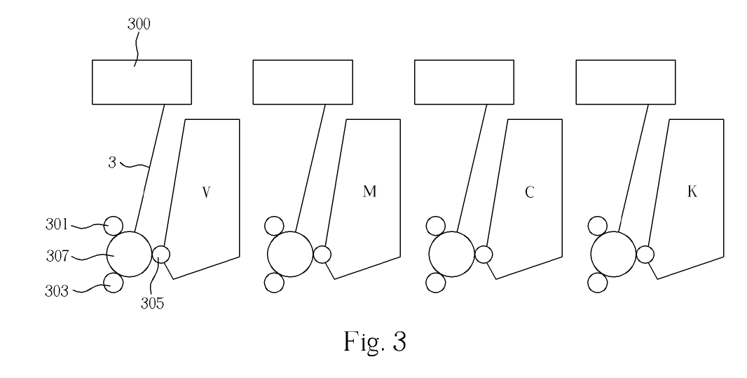

Reference is made to FIG. 3, which is a schematic diagram of a laser electrographic machine in accordance with the preferred embodiment of the present invention. A chromatic laser printer has, for example, black, magenta, cyan and yellow toner cartridges. The yellow toner cartridge Y is connected to a developer unit 305 to spray out the toner. The yellow toner cartridge Y is connected to a photoconductive drum 307, which is conductive if being irradiated and insulated otherwise. First, a roller 303 drives the photoconductive drum 307 to roll and a charging unit 301 charges it to provide uniformly electric charges on a peripheral surface thereof. After irradiation by the laser beam 3 emitted from the laser printhead 300, the non-irradiated areas of the photoconductive drum 307 keep their original electric potential and the irradiated areas have a potential drop so as to attract the toner sprayed out from the developer unit 305. The related mechanisms of the toner cartridges M, C and K have the same operation. It should be noted that the present invention can be applied not only to chromatic laser printers but also to other kinds of laser printers.

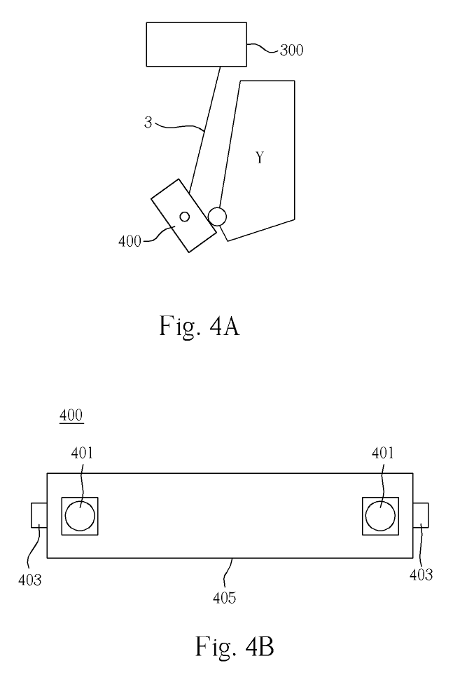

Reference is made to FIG. 4A, which is a schematic diagram of a correction apparatus in accordance with a preferred embodiment of the present invention. After the assembly of the laser printer is complete, the preferred embodiment of the present invention replaces the photoconductive drum with a sensing unit 400. As shown in this figure, the laser printhead 300 emits the laser beam 3 to the sensing unit 400, which has multiple sensors for skew detection.

Reference is also made to FIG. 4B, which shows an enlarged diagram of the sensing unit 400 in accordance with a preferred embodiment of the present invention. The sensing unit 400 has a sensing rod 405 with two sensors 401 and is fixed on a holder via two fixing shafts 403. The holder is originally used to fix the photoconductive drum. The sensing unit 40 is used to receive the laser beam emitted from the laser printhead. If necessary, a light-filtering lens can be disposed in front of the sensing unit 400 to attenuate the power of the laser beam. In addition, an LED beam can replace the foresaid laser beam.

The correction method according to the preferred embodiment of the present invention uses an image-processing system to capture the signals of the laser beam emitted to the sensors 401 of the sensing unit 400. Then, the image-processing system displays the optical signals on its monitor. According to the signals shown on the monitor, one can perform a correction process on the laser printer via his eyes or an instrument.

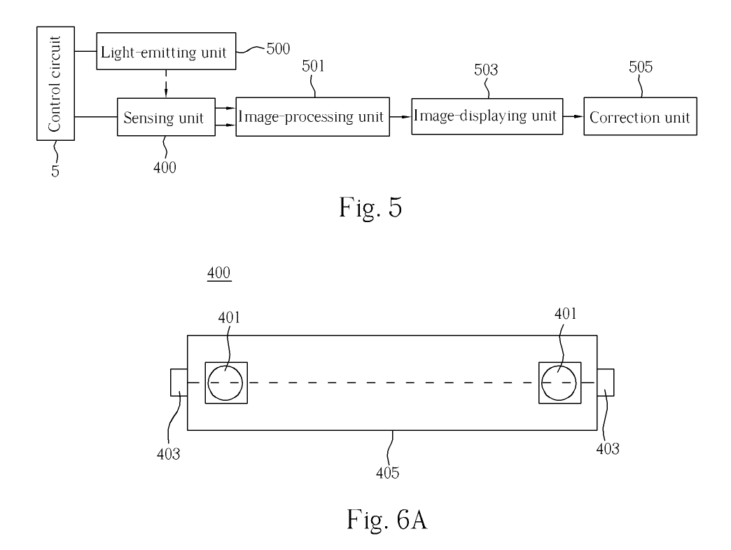

Reference is made to FIG. 5, which is a block diagram of an image-processing system used in the preferred embodiment of the present invention. The image-processing system has an image-processing unit 501 and an image-displaying unit 503. The laser printer has a control circuit 5 for controlling the light-emitting unit 500, such as laser or LED, to emit a scanning beam to the sensing unit 400. The sensing unit 400 having at least two sensors to receive the scanning beam and convert the scanning beam into multiple photoelectric signals. After processing by the image-processing unit 501, the photoelectric signals are shown on the image-displaying unit 503. Subsequently, a correction unit 505 is used to correct the disposition deviation of the light-emitting unit 500 and the laser printer according to the photoelectric signals shown on the image-displaying unit 503. One can use his eye or an instrument to determine whether the photoelectric signals shown on the image-displaying unit 503 are correct or not and thereby adjust the position or angle of the laser printhead of the laser printer to remove the disposition deviation.

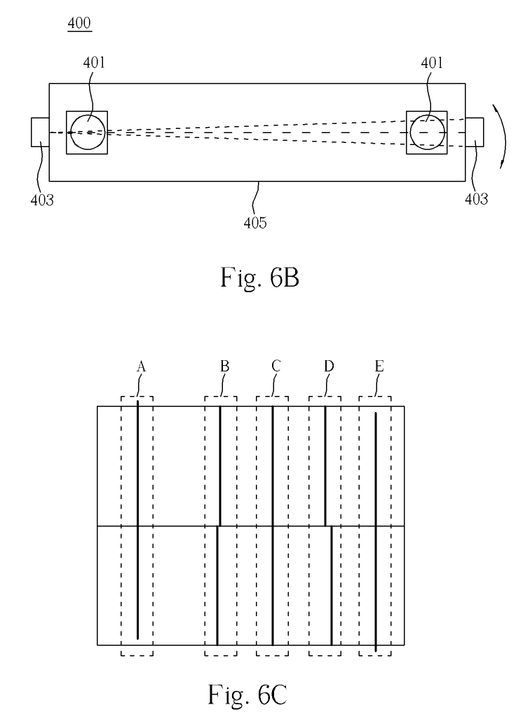

Reference is made to FIGS. 6A and 6B, which illustrate scan lines of the scanning beam emitted to the sensing unit in accordance with the preferred embodiment of the present invention. Since the sensing unit having at least two sensors 401 to detect the scanning beam, the sensors 401 can be used to check whether the light-emitting unit is disposed appropriately. Reference is also made to FIG. 6C, which illustrates various photoelectric signals shown by the image-displaying unit in accordance with the preferred embodiment of the present invention. The image-displaying unit can show an upper stripe line and a lower stripe line to represent the photoelectric signals sent from the two sensors 401. If the upper and lower stripe lines are not aligned, as are the stripe lines B and D, or shifted from the center as are the strip line A and E, disposition deviation of the light-emitting unit is indicated. If the upper and lower stripe lines are aligned and located at the center, as is the stripe line C, no disposition deviation of the light-emitting unit is indicated.

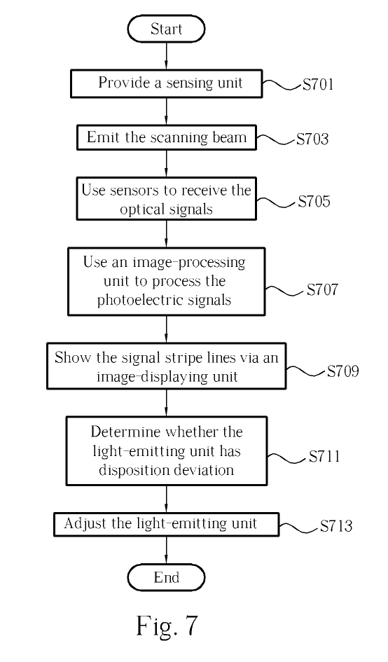

Reference is made to FIG. 7, which is a flow chart of the correction method in accordance with the preferred embodiment of the present invention. Initially, the preferred embodiment of the present invention provides a sensing unit to replace the photoconductive drum of the printing machine, such as laser printer (step S701). Then, the light-emitting unit emits the scanning beam to the sensing unit to form a scan line (step S 703). After that, a plurality of sensors disposed on the sensing unit are used to receive the optical signals of the scanning beam and convert these optical signals into multiple photoelectric signals (step S705). Then, an image-processing unit is used to process the photoelectric signals and convert them into multiple signal stripe lines (step S707). The image-processing unit can be disposed inside or outside the sensing unit. The signals stripe lines are then shown by an image-displaying unit (step S709). Thus, the stripe lines shown by the image-displaying unit can be used to determine whether the light-emitting unit of the printing machine has disposition deviation (step S711). The determination of the disposition deviation can be made by using one's eyes or an instrument. Finally, according to the stripe lines shown by the image-displaying unit, one can adjust the light-emitting unit manually or via an instrument to align the stripe lines and locate the same at the center (step S713).

As the description of the foresaid correction steps, the preferred embodiment of the present invention uses a sensing unit to receive optical signals of the scanning beam and uses the image representing these optical signals to determine whether the printing machine has disposition deviation or the light beam emitted from the light-emitting unit (such as laser or LED) scans the appropriate areas. The present invention can remove the disposition deviation of the printing machine so as to prevent the skew of the image when the same is printed out.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for image correction of a laser printer, the method comprising:
disposing a sensing unit on the laser printer;
emitting a scanning beam from a light-emitting unit onto the sensing unit;
using a plurality of sensors of the sensing unit to receive optical signals of the scanning beam and convert the optical signals into a plurality of photoelectric signals;
using an image-processing unit to receive and process the photoelectric signals;
converting the photoelectric signals into a plurality of signal stripe lines and showing the signal stripe lines with an image-displaying unit; and
determining whether the light-emitting unit has disposition deviation according to the signal stripe lines and correcting a position of the light-emitting unit.

2. The method as claimed in claim 1, wherein in the step of disposing the sensing unit on the laser printer, the sensing unit replaces a photoconductive drum of the laser printer.

3. The method as claimed in claim 1, wherein the method determines whether the light-emitting unit has disposition deviation according to an alignment status of the signal stripe lines.

4. The method as claimed in claim 1, wherein the step of determining whether the light-emitting unit has disposition deviation is performed by checking an alignment status of the signal stripe lines or checking whether the signal stripe lines are shifted from a center.

5. The method as claimed in claim 1, wherein the image-processing unit is disposed inside or outside the sensing unit.

6. The method as claimed in claim 1, wherein the light-emitting device is a light-emitting diode (LED).

7. The method as claimed in claim 1, wherein the light-emitting device is a laser.

8. An apparatus for image correction of a laser printer, the apparatus comprising:
a sensing unit disposed inside the laser printer to replace a photoconductive drum and receive a scanning beam emitted from a light-emitting unit of the laser printer;
a plurality of sensors disposed on the sensing unit to receive the scanning beam and convert the scanning beam into photoelectric signals;
an image-processing unit for receiving the photoelectric signals and converting the photoelectric signals into signal stripe lines corresponding to the scanning beam; and
an image-displaying unit for displaying the signal stripe lines for correcting the light-emitting unit's position.

9. The apparatus as claimed in claim 8, wherein the image-processing unit is disposed inside or outside the sensing unit.

10. The apparatus as claimed in claim 8, wherein the apparatus has light-filtering lenses disposed in front of the sensors to attenuate an optical power of the scanning beam emitted from the light-emitting unit.

11. The apparatus as claimed in claim 8, wherein the light-emitting device is an LED.

12. The apparatus as claimed in claim 8, wherein the light-emitting device is a laser.
